(19) United States
(12) Patent Application Publication
(10) Pub. No.: US 2014/0040163 A1
(43) Pub. Date: Feb. 6, 2014

(54) System and Method for Managing Derivative Instruments

(71) Applicant: trueEX Group LLC, (US)

(72) Inventors: Sunil Hirani, Greenwich, CT (US); James Miller, New York, NY (US)

(73) Assignee: trueEX Group LLC, New York, NY (US)

(21) Appl. No.: 13/864,988

(22) Filed: Apr. 17, 2013

Related U.S. Application Data
(60) Provisional application No. 61/687,088, filed on Apr. 17, 2012.

(51) Int. Cl. G06Q 40/06

(52) U.S. Cl. CPC G06Q 40/06
USPC 705/36 R

(57) ABSTRACT

The present invention is a system and method for providing improved functionality for management of derivative instruments. The improved system includes functionality implementing single interest rate sale sessions initiated either as a result of market conditions or a user request, risk adjustment sales to allow users to balance portfolio risks, consolidated sweeps to more efficiently allow a user to manage an investment swap portfolio, and credit limit clearance functionality to improve the management of credit limits associated with users and clearance facilities.

### PRIORITY INFORMATION

The present application is a utility application, and claims priority to U.S. Provisional Application Ser. No. 61/687,088, filed on Apr. 17, 2012, titled Unwinds Concept, in the names of Sunil Hirani and James Miller, the contents of each of which are incorporated herein in their entireties by reference thereto.

### BACKGROUND

The present invention relates to the management of derivative based financial instruments, commonly referred to as swaps, and more particularly to the provision and distribution of information related to managing swaps to support optimization of portfolios held by companies or traders.

Interest rate swaps, such as simple swaps in which an offeror offers to swap the interest associated with a fixed rate for a notional amount for the interest associated with a variable rate on the same notional amount, or more complex transactions such as a swap involving a switch trade, which involves multiple swaps over different periods of time (referred to as the tenor of the swap) such as a 2×10 switch in which the offeror and an acquirer first implement a simple two year swap, followed by a 10 year swap with the roles reversed (i.e., the offeror first pays interest at a fixed rate, then changes roles and pays interest at a variable rate), allow financial entities to hedge risk associated with interest rates as they vary over time.

While the creation of derivative instruments is important to allow businesses to hedge risk, the ability of traders to optimize the holdings in a portfolio of derivative instruments is equally important. As markets and economies change, so does the optimal portfolio of derivative products for a company or trader, as the derivative instruments are frequently held as a hedge position, to reduce risk to the company or trader in the event of some market or economic change. The need to manage derivative instrument holdings can be brought about by a company or trader's underlying financial obligations no longer existing, such as when a bond or loan which had been hedged has been repaid or called, by a company or trader changing its position on forward rates, or by a company or trader changing its hedge strategy itself, such as by seeking to extend or reduce swap tenors.

Thus, companies and traders may need to adjust the derivative instruments on “positions” held in their portfolio of derivative instruments, such as reducing the number of instruments under which a fixed interest rate position has been taken counter to a variable interest rate position, or vice versa. While positions may be reversed by entering a new swap, a company or trader may equally prefer to allow another entity to step into the first company or traders position in a swap, thus relieving the first party of the financial obligations of the swap (as well as transferring financial benefits to the other party, referred to hereafter as the “step in ply”).

The ability to adjust a portfolio with respect to its content may not always be easy to accomplish. Previously entered into swaps may no longer enjoy liquidity, such as when the swap is no longer an “on-the-run” position, and interest in the terms of the swap has waned. Simply inducing a counter party to cancel out a swap, or “unwind” it, may have financial implications for the counter party, such that the counter party may seek remuneration for the unwind. Finally, margin considerations may complicate any efforts to manage a portfolio, as margin costs may be dependent on the particular positions at issue, the related clearing houses, or other factors.

To this end, the first party trader may desire to either reposition positions between internal portfolios or accounts, referred to hereafter as rebalancing, identify step in parties to allow the transfer of derivative instrument positions to one or more of those step in parties, referred hereafter to as termination, to reduce the number of different derivative instrument holdings within a portfolio, referred hereafter to as compaction, or to convert positions which were client cleared at inception into clearing house cleared positions, referred hereafter to as back-loading transactions.

Rebalancing of a portfolio allows a user of the system to transfer positions from one internal fund to another, whether the prior swaps are cleared swaps or bilateral trades. In the situation wherein the position is a cleared trade, the transfer of a position from one internal portfolio to another is affirmed with a central counterparty or clearing house. As the reassignment of the position is internal, the user may or may not desire to address financial impacts of the repositioning. Where the position has a counterparty associated with the swap, the internal transfer of the position may be affirmed with the counterparty to the trade.

Termination of existing positions involves the identification of a step in party to assume the benefits and obligations of a position. As the benefits and obligations of an existing position may have beneficial or adverse characteristics at the time of the termination of the position, such as due to changes in interest rates in the period since inception of the swap, step in parties may offer or require additional financial considerations before stepping into a position, such that the transaction must address those financial considerations, as well as the clearing of the position termination and assumption itself.

Where a user wants to rebalance a portfolio between internal accounts or portfolios, and to address the necessity of financial considerations concurrently, the rebalancing may be handled as a termination of the first internal account, with the second internal account functioning as the step in party.

An owner of a portfolio who desires to move away from a position taken may alternately desire to simply unwind the position, i.e., to cancel the original swap by terminating both the position taken by the user, as well as the counter party, such that the original swap is nullified. While the effect may be the same for the user desiring to unwind the swap, the effect carries over to the counterparty, whose positions are concurrently obviated during an unwind.

Users may want to reduce the number of positions held in a portfolio, without changing the aggregate position in the portfolio. Such a desire may be accomplished by compacting the positions into a reduced number of or a single position, having a similar risk profile and obligations and benefits as the aggregated benefits and obligations of the non-compacted portfolio.

Under recent changes to requirements associated with derivative instruments, swaps are required to be cleared through a clearing house. While the regulations do not apply to pre-existing trades, benefits may accrue to the holder of those positions if the positions are cleared through a central counter party (“CCCM” or “clearing house”) clearing house. Accordingly, holders of portfolios may desire to have those pre-existing positions cleared through a clearing house, referred to as back-loading.

The management of existing positions is dependent on valuing the present position, as well as connecting users and potential step-in parties, existing counterparties, and clearing houses to allow management of an existing portfolio.

### SUMMARY OF THE INVENTION

The present application is a system and method for providing a derivative instrument management system that allows a user to efficiently and transparently adjust existing positions within a portfolio.

In a simple form, the system of the present invention is a computer implemented derivative management (“DM”) platform having a computer system including a plurality of user interfaces. The computer system may be provided with functionality to enable the DM platform or system to implement intake of client portfolio information, and/or to process terminations, rebalancing, unwinds, compactions, and back-load transactions. The platform and system may be provided with communications functionality to acquire information regarding positions in a user's portfolio from third party sources, as well as to internally generate valuations of properties in a portfolio, or to obtain valuations from unrelated third party valuation services.

### BRIEF DESCRIPTION OF THE FIGURES

FIG. 1 illustrates a system for system for implementing a derivatives instrument management system according to the present invention.

FIG. 2 illustrates a spreadsheet format including portfolio information for a user's positions for inclusion within a derivative instrument management system according to the present invention.

FIG. 3 illustrates a data display of portfolio information associated with a user, including controls for implementing the functionality of the present invention.

FIG. 4 illustrates a simplified termination process according to the present invention.

FIG. 5 illustrates a selection screen for allowing a user to identify a desired clearing house for clearing a transaction according to the present invention.

FIG. 6 illustrates a notional display for allowing a user to attribute portions of financial considerations received or paid in association with a transaction according to the present invention.

FIG. 7 illustrates a simplified process for an unwind transaction according to the present invention.

FIG. 8 illustrates a notional display for allowing a user to identify positions for compaction according to the present invention.

FIG. 9 illustrates a notional display for displaying a compaction offer to a user in which a single position is offered to offset the positions included in the compaction request.

FIG. 10 illustrates a simplified process for portfolio intake according to the present invention.

### DETAILED DESCRIPTION OF THE INVENTION

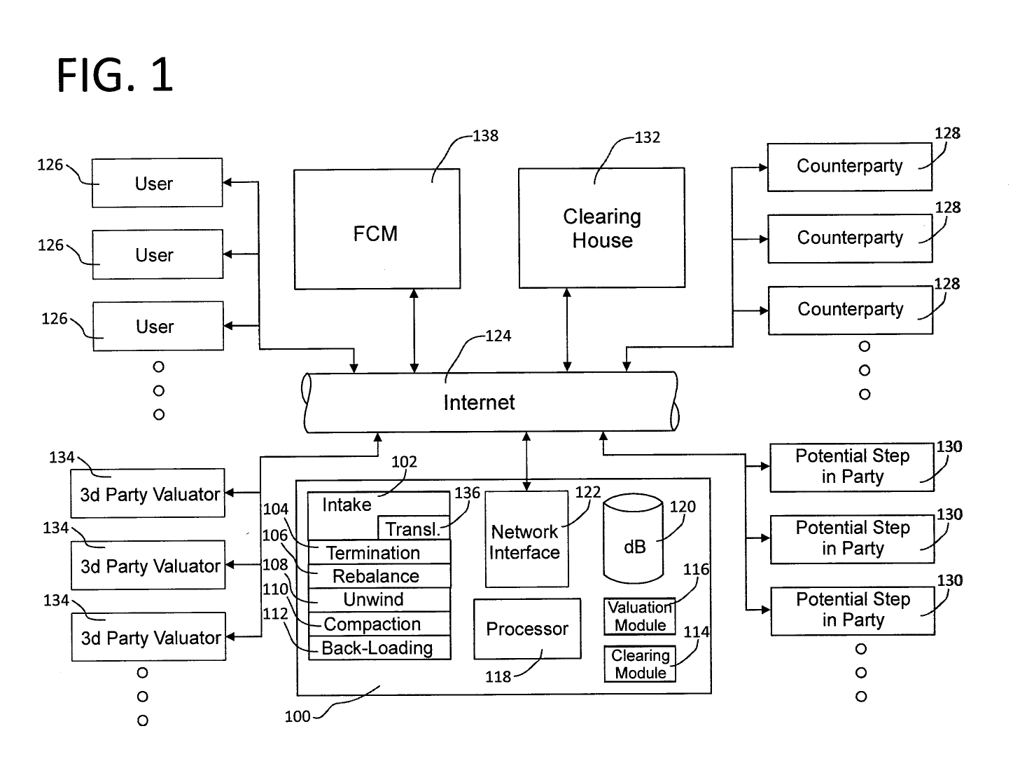

As shown in the Figures, in which like numerals are used to identify like elements, there is shown an embodiment of the present invention. In FIG. 1, there is shown a derivative instrument management system 100 for implementing management activities for derivative instruments.

The derivative management system 100 (hereafter “DM System”) may utilize multiple functional modules, to address different aspects of the process associated with providing the DM System. While these are described in terms of modules, nothing requires modular construction of the system and method in accordance with the present invention, modules are simply used for the added clarity they allow to the below discussion. These modules may include portfolio intake 102, termination 104, rebalancing 106, unwinds 108, compaction 110, and back-loading 112. These modules may be supported by a clearing module 114 which addresses communications with clearing houses to ensure compliance with financial reporting requirements. The system may further include a valuation module 116 for determining or assessing a present time value associated with a position. Finally, the system may include a processor 118 for processing instructions and communications between the various entities involved in the process, a database 120 for storing portfolio, transaction, and communications information. The system may be further provided with an interface 122 to allow communications between the various parties, such as via the internet 124, as well as for generation of informational displays for the parties.

The system may operate in an environment having users 126 who desire to manage portfolios connected to the system, as well as counterparties 128 of existing swaps and potential step in parties 130. Additionally, one or more central counter party clearing houses 132 may be communicably connected to the system, such that transactions implemented through the DM system 100 may be reported to a clearing house 132 and cleared, before the transaction is finalized.

While the system itself may include valuation functionality within the system itself, communications with one or more third party valuation services 134 may be implemented such that users 126, counter parties 128, and/or potential step in parties 130 may utilize the services of those third party valuation services 134 to assess the benefits and costs of a position change.

Portfolio Intake Module

Portfolio intake allows a user of the DM system 100 to provide information regarding a user's portfolio, such that the user can use the functionality of the DM system to unwind, terminate, or compact properties within the user's portfolio. If the user's portfolio information is already resident on a database 120 associated with the DM system 100, the user can avoid the necessity of providing the information before being able to utilize the DM system 100.

In one situation, the portfolio of a user may already be being managed through a derivative instrument trading system, such as that disclosed in pending U.S. patent application Ser. No. 13/446,998, titled “Method and System for Interest Rate Swaps”, filed on Apr. 13, 2012, the entire disclosure of which is incorporated herein by reference thereto. The present system may be implemented as an adjunct to such a system, or as a standalone system. If the system is implemented as a standalone system, information concerning the portfolio of a user may be transferred from the system presently being used through a translation sub-module 136 which may re-format the data from a format associated with the presently in use system into a format consistent with the DM system 100. Data translation strategies may be chosen based on the format of the existing data. User specific formats may require the development and implementation of specific translation parameters, such as to convert a proprietary format into a format common to the DM system, or into a common format that can imported into the DM system 100 utilizing an existing import capability. For example, one common format for portfolio data is the CME Trade Register format. In the case of a user proprietary format, the data may first be exported from the proprietary format into CME Trade Register format, before being imported into the DM system 100 by a translator which translates the CME Trade Register format into the DM system specific format. Alternately, the DM system 100 may be implemented using an existing common format, such as the CME Trade Register format. Alternately, a user may provide identifiers of positions, such that the intake module 102 may request full characteristics of those positions from a clearing house 132.

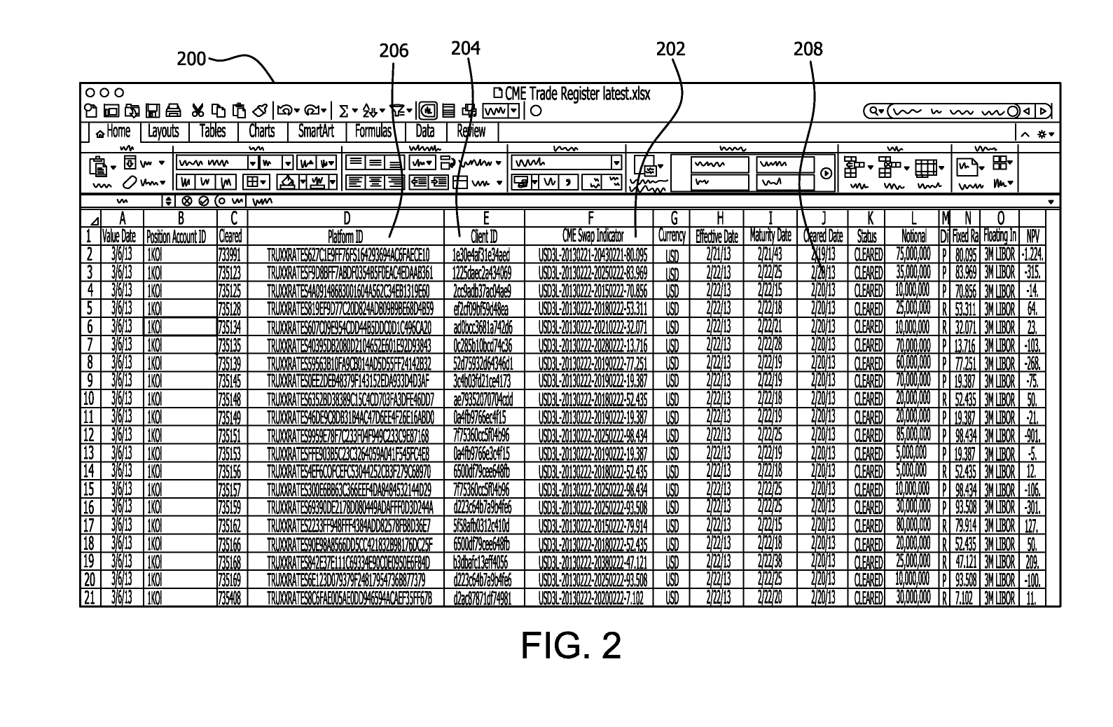

One possible format for a user portfolio for inclusion in the DM system 100 database 118 is shown in FIG. 2, illustrating user data stored in a spreadsheet 200 format. The spreadsheet may include an identifier 202 associating a position with the records of a clearing house, such that information regarding the position can be retrieved from the clearing house. The spreadsheet may also include an identifier 204 that the user uses to identify the position internally, as well as an identifier 206 for identifying records associated with a position stored in a separate derivative instrument management system. Parameters 208 defining the position may also be contained in the spreadsheet, to assist in valuing the position, or may alternately be retried from a third party source, such as a clearing house 132.

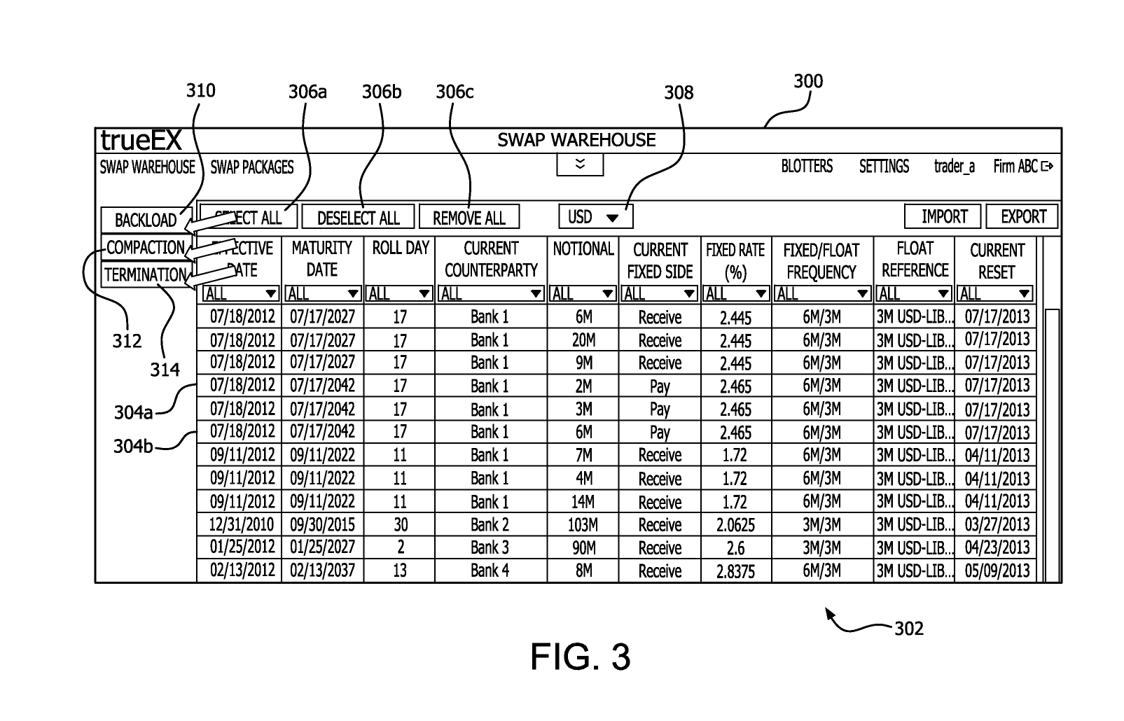

FIG. 3 illustrates a data display 300 of a portfolio once it has been imported into the DM system 100. Parameters 302 associated with a position may be included, to assist the user in evaluating positions for which management operations, such as rebalancing or compaction, may be desired. Positions 304a, 304b, etc., may be individually selectable, selectable as groups (such as relevant for compaction), or selectable en masse. The display may include functional tools 306a, 306b, 306c for selecting positions for management. The display may also include a drop down box 308 for selecting a currency in which values associated with positions may be displayed. The display may also include selection buttons 310, 312, 314 for selecting a management function to be implemented with respect to selected positions.

Termination

Termination of existing positions involves the identification of a step in party to assume the benefits and obligations of a position. As the benefits and obligations of an existing position may have beneficial or adverse characteristics at the time of the termination of the position, such as due to changes in interest rates in the period since inception of the swap, step in parties may offer or require additional financial considerations before stepping into a position, such that the transaction must address those financial considerations, as well as the clearing of the position termination and assumption itself.

Where a user wants to rebalance a portfolio between internal accounts or portfolios, but to address the necessity of financial considerations concurrently as well, the rebalancing may be handled as a termination of the first internal account, with the second internal account functioning as the step in party.

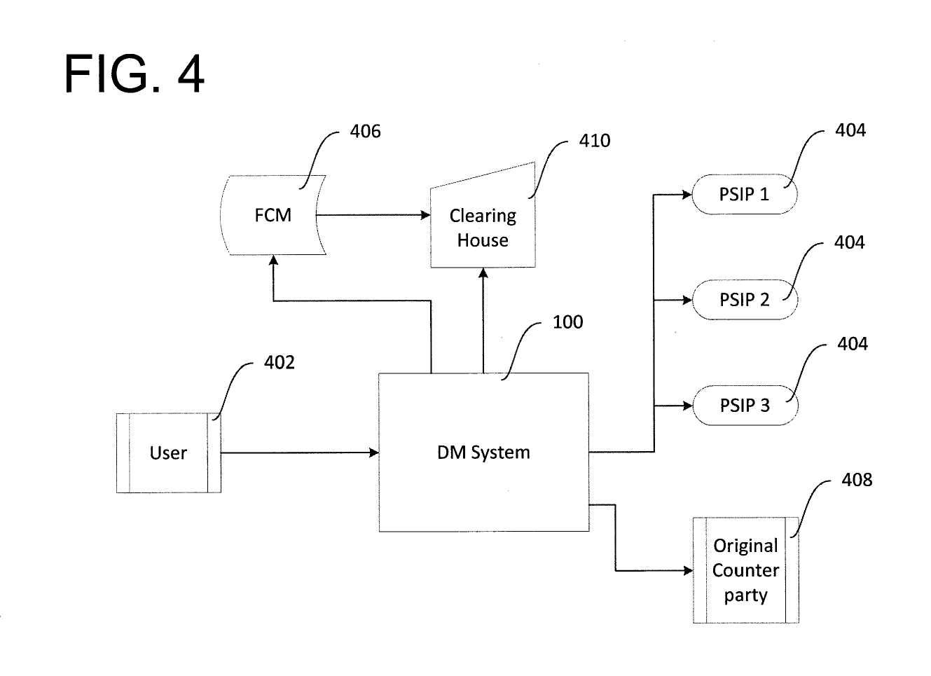

FIG. 4 illustrates a simplified process associated with terminating and assigning trades. The user or originator 402 of the termination request submits positions identified for termination to the DM system 100. The user 402 may also identify potential step in parties 404 from which the user 402 desires to receive offers for the positions identified for termination. The potential step in parties 404 may make offers for the positions, or may decline to provide an offer. Any offers made may be transmitted to the user 402, who may accept a preferred offer. The offers may be made as a block offer, i.e, a single set of financial terms under which the potential step-in party would assume the benefits and obligations of a position, or may be an aggregate offer, i.e., a single set of financial terms under which the potential step in party would assume the benefits and obligations of the positions identified for termination.

A list of potential step in parties may be provided to the user 402, from which the user 402 may select potential step in parties 404 that the user 402 would potentially accept offers from. In such a case, the identity of the potential step in parties 404 could be significant to the user 402, such that user identity could also be of significance to the potential step in parties. In such a situation, it may be equally possible that the potential step in parties do not desire to be involved in any potential step in transaction. Accordingly, the system may be implemented such that potential step in parties 404 could indicate a desire to act as potential step in parties 404 to the DM system 100, while filtering information to the user 402 to make the potential step in party 404 anonymous. In addition to potential step in parties 404 listed by the DM system 100, the user could identify additional potential step in parties (not shown), such that those user identified potential step in parties would be included in any informational transmission regarding the user's desire to terminate positions through the DM system.

Once selected, the preferred offer may be forwarded to a futures commission merchant (“FCM”) 406 who may assist in resolving the transaction, such as by offering credit to a step in party 404, or otherwise perform as a broker in the transaction.

The amount of an offer presented by a potential step in party may be determined in any of several fashions. At one end of the spectrum, the potential step in party may simply provide a financial consideration, such as an offer or purchase price for the entire portfolio. At the other end of the spectrum, the potential step in party could use a valuation service to identify a present time value for individual positions within the portfolio offered for step in. Alternately, the potential step in party may use a valuation for informational purposes, but modify the offer based on circumstances or expectations of which the potential step in party is aware (i.e., a belief that the market will change in certain ways, or a circumstance within the portfolio of the potential step in party wherein stepping into the offered positions would provide additional benefits to the potential step in party.

In order to support the potential step in party with respect to the amount of an offer to be made, the DM system may use internal valuation functionality, which uses the terms and characteristics of the offered positions to determine a present value associated with each position up for termination. The present value assessment may address the open market value of the position in view of current market conditions, as well as estimate any margin, such as a clearing margin, associated with a transaction involving the positions. This value may be presented to the user to allow the user 402 to evaluate the merits of offers, as well as presented to a requesting potential step in party 404, for their own analysis. Alternately, either or both the user 402 and the potential step in party 404 may desire to have the valuation performed by a third party external to the DM system 100, not necessarily the same third party for both user and potential step in parties. In such a situation, the DM system 100 would receive a request from a user 402 and/or a potential step in party 404 to obtain the third party valuation. Such a request could be initiated by actuation of a soft button on a display of the positions that the user is offering for termination, either being displayed to the user or to the potential step in party. Upon actuation of the soft button, the DM system 100 would query the requesting party (i.e., the user 402 or a potential step in party 404) to select a third party valuation provider from a list of potential third party valuation providers, as well as query the requester to identify a different third party valuation provider should the requester desire a third party valuation service not identified on the list provided from the DM system 100.

Upon receipt of a valuation request, the DM system 100 may generate a present value determination for the positions for which termination offers are being requested, or may communicate a request for a valuation to a third party valuation provider. Upon receiving valuation results from a third party valuation service, the DM system 100 could then report them to the requester. As the provision of such services may not be free, the DM system 100 may include functionality for accounting the cost of such services, and recovering such costs from the requester. Alternately, the provision of a valuation generated by the DM system 100 itself may be charged against the requester, or used as a loss leader to generate interest in use of the DM system 100 by users and potential step in parties 402.

Once an offer has been entered by a potential step in party 404, the offer may be communicated to the user 402. Once received by the user 402, the user 402 may be provided with a time limit for accepting or denying the offer, after which the offer becomes conditional on re-acceptance by the potential step in party 404. Under such circumstances, an accepted offer may be transmitted to the potential step in party 404 for the potential step in party 404 to confirm that the offer remains valid, or the potential step in party 404 may make an amended offer. The potential step in party may alternately withdraw from the potential transaction. An amended offer may be supported by another cycle of valuation analysis, as discussed above.

Once an offer has been accepted by the user 402, and confirmed by the potential step in party 404 if warranted, the proposed transaction may be communicated to the original counter-party 408 for approval if such approval is warranted or necessary, i.e., if the original swap was a client cleared trade. Once approved by all necessary parties, the transaction may be reported to a clearing house 410, as well as to an FCM 406 if one is involved in the transaction if involved.

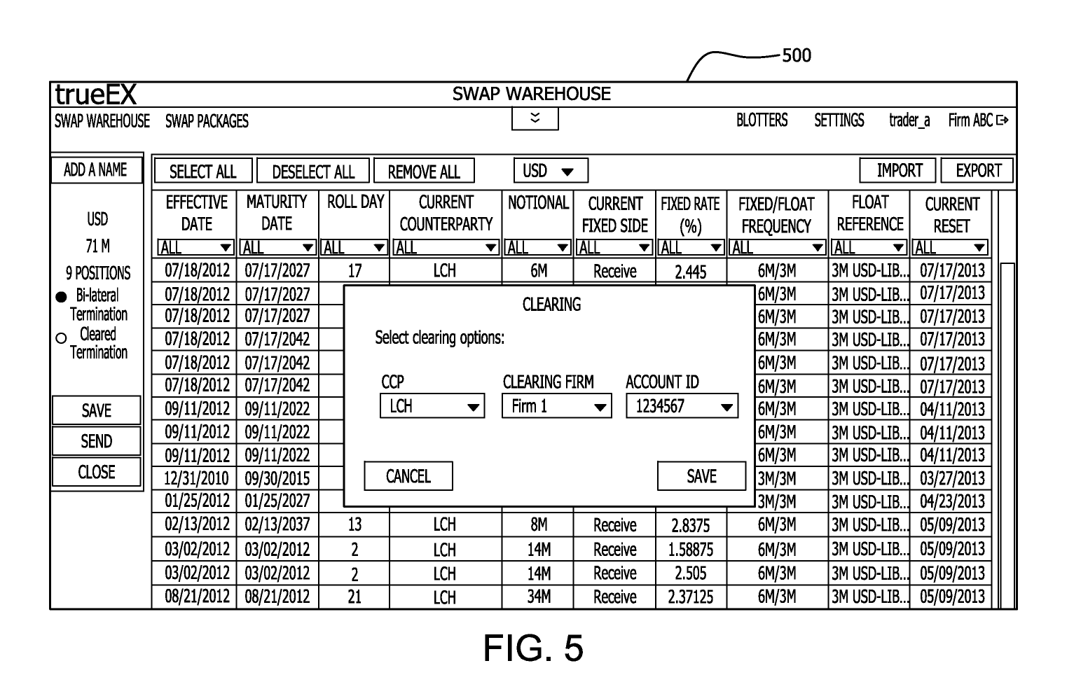

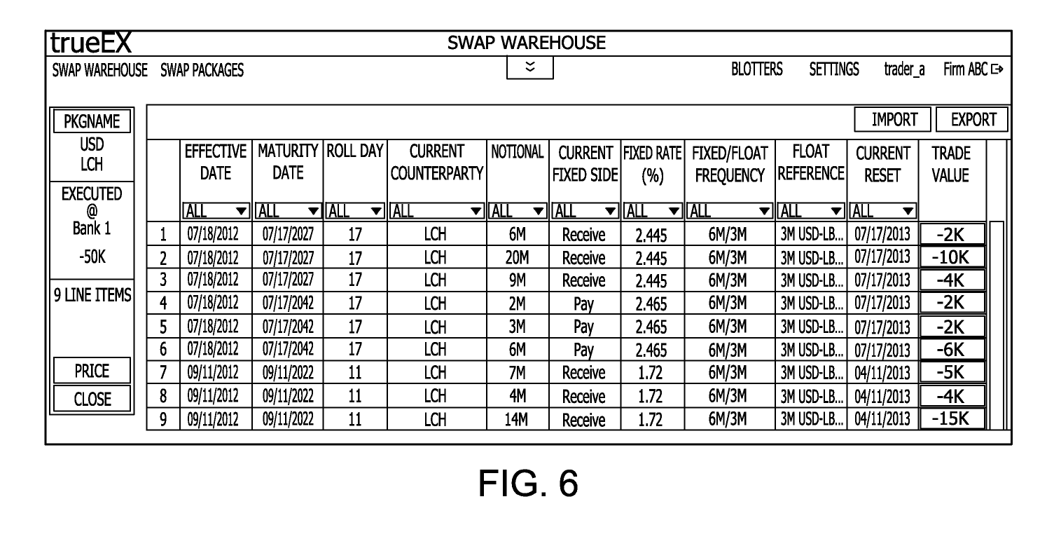

FIG. 5 illustrates a selection screen 500 for allowing a user to identify a desired clearing house. Once approved/executed by the clearing house 410, the portfolios of the relevant parties may be modified to reflect the transaction, such that portfolio views are appropriately updated.

Where the offer was an aggregate offer, i.e., a single financial set of financial considerations, a display may be presented to the user to allow the user to designate portions of the financial considerations to be attributed against individual positions which were terminated, for internal accounting purposes. Such a display is shown in FIG. 6.

Rebalancing

Rebalancing of a portfolio allows a user of the system to transfer positions from one internal fund to another, whether the prior swaps are cleared swaps or bilateral trades. In the situation wherein the position is a cleared trade, the transfer of a position from one internal portfolio to another is affirmed with a central counterparty or clearing house. As the repositioning of the position is internal, the user may or may not desire to address financial impacts of the repositioning. Where the position has a counterparty associated with the swap, the internal transfer of the position may be affirmed with the counterparty to the trade.

In the DM system 100, the process would be similar to that undertaken with respect to terminations, however the step in party would be the second internal portfolio. With respect to a rebalancing transaction, rather than the user 126 being provided with a list of potential step in parties, the user would be presented with a list of internal portfolios which are candidates for the internal reassignment. The user 126 could again request valuation of the properties, to assist in internal accounting, if desired by the user 126. If the positions identified for compaction were cleared swaps, the user could also be queried to identify a clearing house 132 for the transaction. If the positions identified for compaction are client cleared trades, the counterparty to the positions could be queried for approval of the rebalancing. Once any necessary approvals had been obtained, the transactions could be reported to a clearing house to meet regulatory requirements.

Unwinds

An owner of a portfolio who desires to move away from a position taken may alternately desire to simply unwind the position, i.e., to cancel the original swap by terminating both the position taken by the user, as well as the counter party, such that the original swap is nullified. While the effect may be the same for the user desiring to unwind the swap, the effect carries over to the counterparty, whose positions are concurrently obviated during an unwind.

An unwind or tear up involves identifying positions which the user desires to obviate. As a counter party remains in existence, the concurrence of the counter party is necessary, as the unwind should also obviate the counter party's obligations and benefits concurrently with the users obligations and benefits. An unwind may be accomplished on the DM system 100 by the user 126 identifying one or more positions that the user 126 desires to unwind. Unwinds may typically be applied to client cleared swaps, such that the counter party is a unique party 128 known to the user 126, as opposed to a swap cleared through a clearing house 132, as in that situation there is no identified or identifiable counterparty (i.e., the clearing house functions as an intermediary to both original parties.)

Positions for submission for unwinding may be selected from a list of positions in a portfolio, using similar functionality to that as discussed above with respect to terminations. Once identified as a candidate for an unwind, information concerning the position or positions that have a known counterparty may be communicated to the counterparty for those positions through the DM system 100. Again, as the potential unwind may have financial impacts apart from the simple unwind, either party may invoke a valuation of the positions, in order to best assess their positions. For example, one counter party may believe that due to market changes, its position is the better of the two positions, such that although it may be willing to unwind a swap, it believes additional financial considerations should be provided to it for the unwind. Accordingly, the counter party may obtain a valuation of its position, as well as the counter position, as a tool for determining the merits of accepting an unwind. Such a valuation may be accomplished either using a DM system 100 valuation function 116, or by requesting and obtaining a third party valuation 134 through the DM system 100.

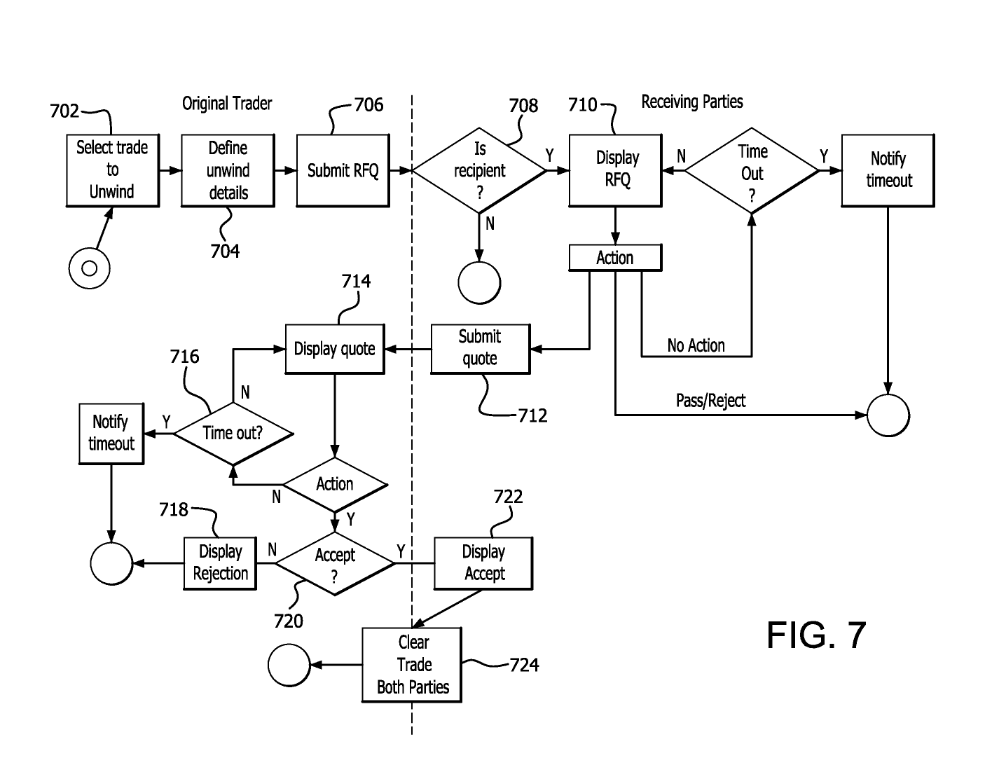

FIG. 7 illustrates a flow chart showing a simplified unwind process. The request to unwind a transaction may be a simple offer, i.e, a simple identification 702 of the positions that the user wishes to unwind with no additional financial consideration, or a compound offer, for which the user can identify details 704 associated with the unwind request such as an offer or demand for additional financial considerations.

The DM system may aggregate additional information associated with the request, and communicate 706 the request to the counterparty by displaying 710 it on the counterparty's user interface with the DM system, or by transmitting a communication to the counterparty via e-mail or other communications methods. In one embodiment, the DM system will compare 708 the identification of potential counterparties with identification of the counterparty of positions for which an unwind is sought, and display 710 the request for an unwind only to the proper counterparty. The counterparty may invoke their own valuation, or conduct other investigations of the merits of accepting the unwind request. As a result of any investigations, or without conducting any investigation at all, the counterparty may indicate either acceptance of the request to unwind, at which point a quote may be returned 712 to the user, refusal of the request to unwind, or acceptance of the request to unwind conditioned on amended additional financial terms (i.e., an amended quote). This indication may be transmitted via the DM system 100 to the user, and displayed 714 for the user's consideration.

Upon receipt of the response from the counterparty, the user may accept or reject the response of the counterparty. Because any terms of the unwind may be affected by market changes, a time period for response may typically be imposed, such that a response or counteroffer may expire after a certain period of time, unless confirmed by the counterparty outside of that time window. In one embodiment, if the user does not accept a counteroffer or quote received from the counterparty, the process may timeout 716 and display a rejection 718 of the counteroffer or quote. If the user accepts 720 the counteroffer or quote, the acceptance may be displayed 722 on the counterparty's display, and the trade may be cleared 724 for both parties.

In the event that additional financial terms are proposed in association with an unwind, an FCM may be utilized to broker those additional considerations. Once approval of all parties has been indicated, the proposed unwind may be implemented under the agreed to terms, and reported to a clearing house as appropriate. Finally, the portfolio records of the party and the counterparty may be updated to reflect implementation of the unwind.

Where the unwind transaction involves a clearing house cleared transaction, the request to unwind can be transmitted to multiple parties for proposals from those parties, i.e., to identify parties who have off-setting positions that they wish to unwind as well. Accordingly, the request for an unwind can be sent to multiple parties, each of who may offer positions of their own to be used to offset the positions of the user that the user would like to unwind. Again, as market conditions can change the value of positions being offered for an unwind, a time limit may be placed on the potential unwind partners within which to make a counter offer before the request for a counteroffer expires. Where a party responds with a proper position to offset the position desired to be unwound by the user, the user may accept that proposal, at which time the off-setting positions may be crossed, with the appropriate clearing house notified of the unwinding of the respective positions, such that the positions are obviated. Again, as above, the parties may utilize valuation tools to assist them in evaluating positions to unwind, as well as the business benefit of such potential unwinds, such that the user or the potential unwind partner may offer or request additional financial considerations to be included in the unwind transaction. Again, an FCM may be involved in the process, to allow any such financial considerations to be transacted between the parties, as a precursor to the transaction being forwarded to a clearing house for clearing of the unwind.

Compactions

Users may want to reduce the number of positions held in a portfolio, without changing the aggregate position in the portfolio. Such a desire may be accomplished by compacting the positions into a reduced number of positions or a single position, having a similar risk profile and obligations and benefits as the aggregated benefits and obligations of the non-compacted portfolio.

For a user 126 to seek compaction, the user 126 would need to identify an alternate party, having one or more positions that could be traded with the user to allow the user to reduce the number of positions in the user's portfolio. The process through the DM system would be similar to the process for terminations, with the alternate party taking the role of a step in party if in a termination, however the offer could include one or more positions to be offered by the alternate party, as well as financial considerations or not.

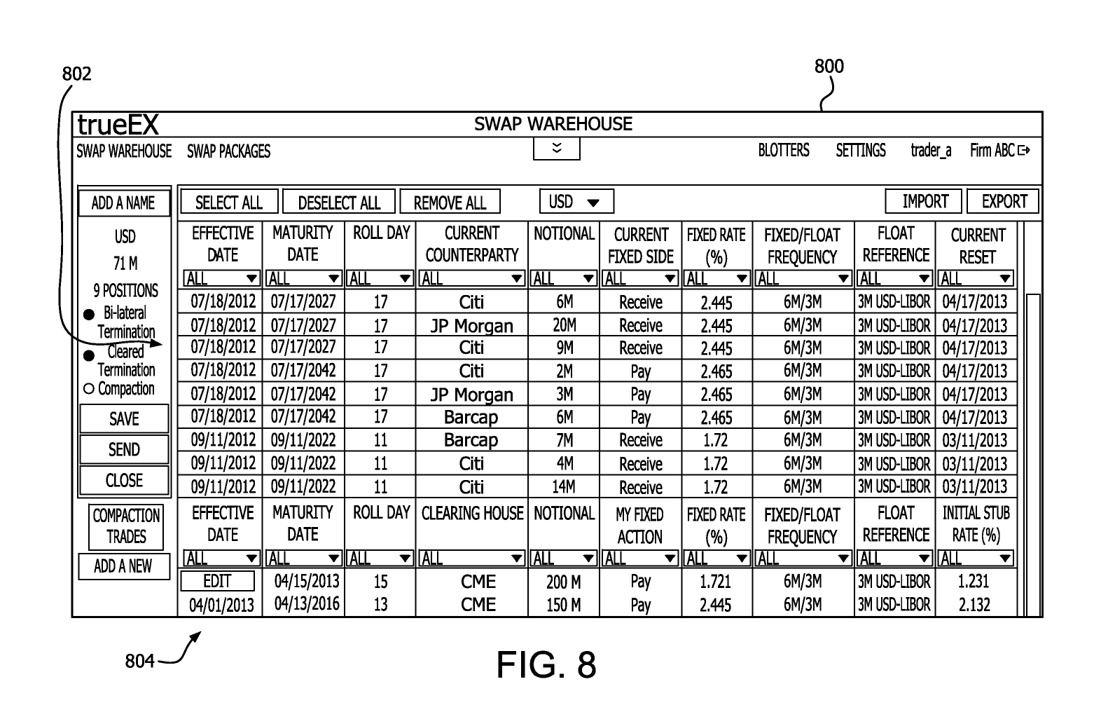

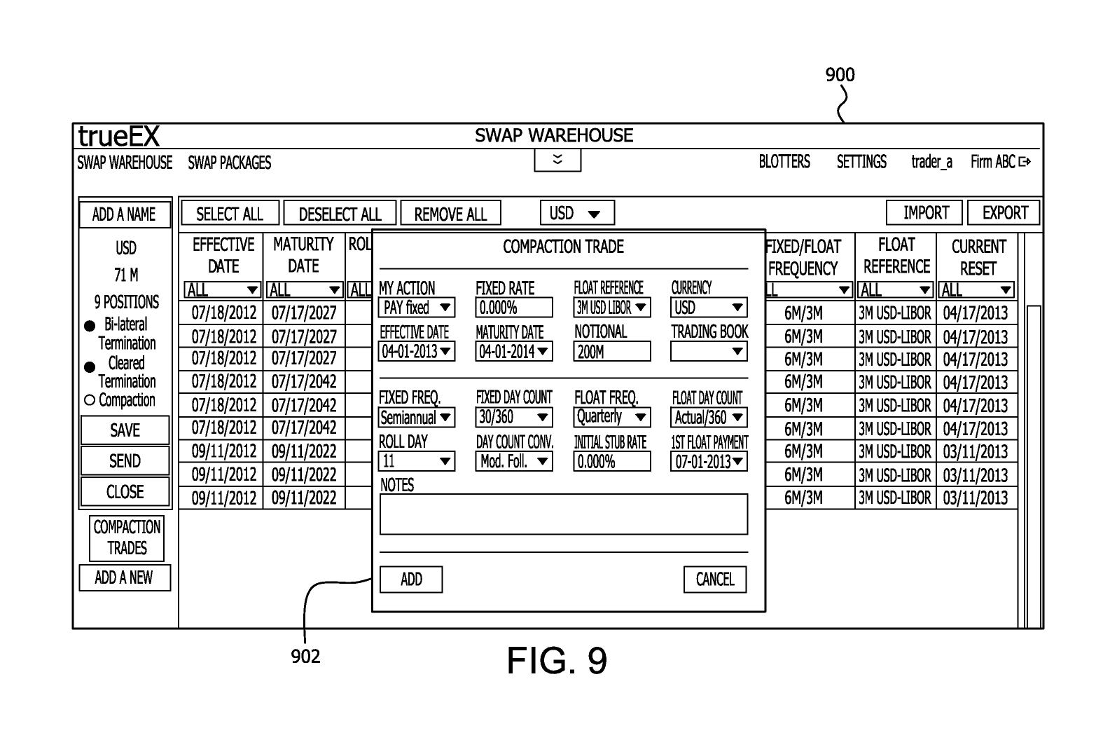

A compaction could be initiated similarly to a termination, with the user identifying positions that it desired to compact, and selecting potential alternate parties. FIG. 8 illustrates a notional display 800 to allow a user to identify positions for compaction. The upper portion of the display 802 may show positions in the user's portfolio, while the lower portion 804 may be used to list positions to be included in a compaction package. The DM system 100 may then publish the positions offered to be compacted to the alternate parties identified by the user, and the alternate parties could again submit offers through the DM system to the user. The user would again have a time limit within which to accept a preferred offer, after which acceptance of the preferred offer would be conditioned on confirmation by the alternate party. FIG. 9 illustrates a notional display 900 for displaying a compaction offer 902 to a user in which a single position is offered to offset the positions included in the compaction request.

Back-Loading Bilateral Trades

Under recent changes to requirements associated with derivative instruments, swaps are required to be cleared through a central counter party clearing house. While the regulations do not apply to pre-existing trades, benefits may accrue to the holder of those positions if the positions are cleared through a clearing house. Accordingly, holders of portfolios may desire to have those pre-existing positions cleared through a clearing house.

Back-loading bilateral trades through the DM system 100 may be accomplished in a similar fashion to other management processes, with the user desiring to back load one or more bilateral trades first selecting those positions from a portfolio display. Counterparties for those trades may be notified through the DM system 100 of the user's desire to back load those trades, and indicate either acceptance or rejection of the back load request. If the back load request is denied, the process can stop at that point. If the counterparty indicates an acceptance of the backload, the DM system 100 may create replacement trades equivalent to the present position of the swaps being back-loaded, and implement the replacement trades through a clearing house concurrently with unwinding the original trades, such that the original trades are obviated, and the new swaps are cleared through a clearing house. Once the new swaps have been cleared through the clearing house, information on the new trades can be added to the portfolio information of the user and the counter party, and information related to the original swap removed from the portfolio information.

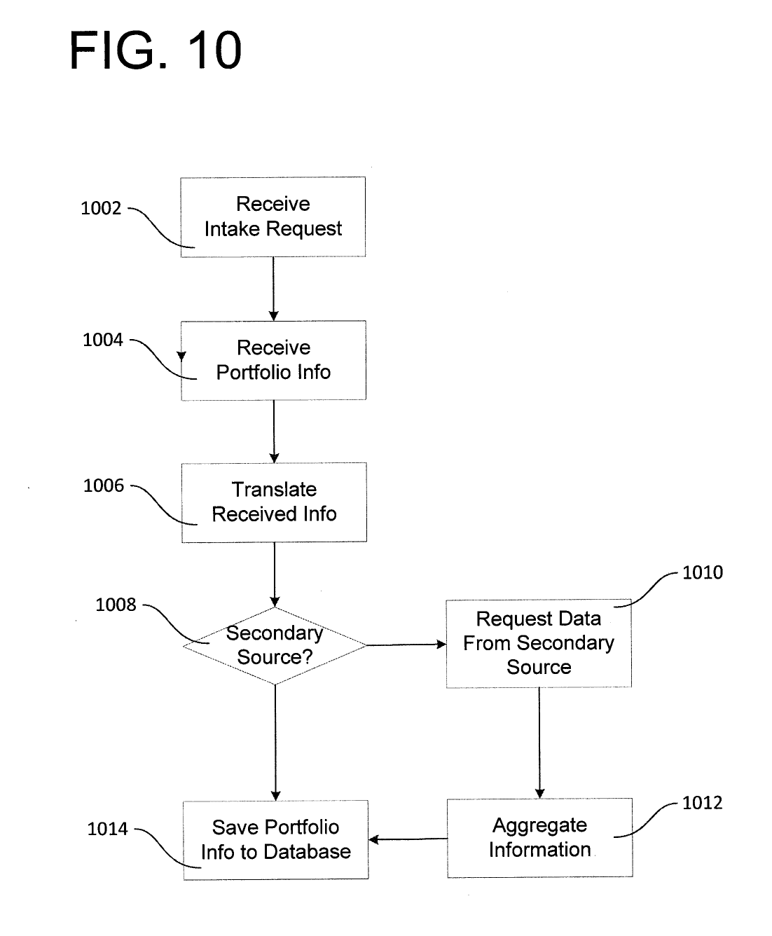

FIG. 10 shows a simplified process for portfolio intake. The DM system 100 may receive a request 1002 to add a portfolio to the DM system 100 database 120 to allow a user 126 to manage a portfolio on the DM system 100. Once the request has been received, the DM system 100 may then receive information 1004 identifying the portfolio. The information may then be translated 1006 into a format suitable for use by the DM system 100. Once the information has been translated, the information may be parsed to determine 1008 if further information needs to be acquired from a secondary source. If information from a secondary source is desired, such as a clearing house, the DM system 100 may request 1010 the information from the secondary source. The secondary source may then provide the necessary information, which may be received by the DM system. The DM system may then aggregate 1012 the received information with the information provided by the user 126. The portfolio information may then be stored 1014 in the DM system database to allow a user to manage the portfolio.

The present invention may be embodied in other specific forms without departing from the spirit or essential attributes of the invention. Accordingly, reference should be made to the appended claims, rather than the foregoing specification, as indicating the scope of the invention.

What is claimed is:

1. A computer-implemented derivative instrument management system comprising:
a computer platform having: an interfaces that elicits and receives information from users of the system; an interface that allows communications with a clearing house for requesting clearing of management transactions associated with one or more positions associated with a user's portfolio; a database for storing information associated with a user's portfolio; and instructions for implementing a management transaction associated with one or more positions held by a user;
wherein said management transaction includes communicating a request for a second party to respond to a request to act as a secondary party to a proposed management transaction, receiving from said second party acceptance of said request to act as a secondary party to said management transaction; displaying said acceptance to said user, and communicating an accepted transaction to a clearing house.

2. A computer-implemented derivative instrument management system in accordance with claim 1, wherein said transaction comprises a termination transaction, and wherein said second party responds with an offer for the second party to step into the position of the first party.

3. A computer-implemented derivative instrument management system in accordance with claim 2, wherein said offer further comprises a proposed financial consideration required by said second party before said second party will accept said request.

4. A computer implemented derivative instrument management system in accordance with claim 2, wherein the time within which said second party can accept said request is limited by said instructions resident on said computer platform.

5. A computer implemented derivative management system in accordance with claim 2, wherein the time within which a user can implement an acceptance by a second party is limited by said instructions resident on said computer platform.

6. A computer implemented derivative management system in accordance with claim 1, wherein said computer platform further comprises instructions for determining a value associated with positions proposed for said management transaction.

7. A computer implemented derivative management system in accordance with claim 6, wherein said value comprises an estimation of present market value of positions proposed for said management transaction.

8. A computer implemented derivative management system in accordance with claim 6, wherein said value comprises an estimate of margin fees which would be incurred by a party as a result of a proposed management transaction.

9. A computer-implemented derivative instrument management system in accordance with claim 3, wherein said management transaction further includes coordination of said management transaction with a broker for accommodating an exchange of consideration associated with said management transaction.

10. A computer implemented derivative instrument management process, comprising the steps of:
Receiving at a derivative management platform a request from a user to initiate a proposed management transaction;
Receiving at said derivative management platform identification from said user of one or more derivative positions that said user would like to include in said proposed management transaction;
Receiving at said derivative management platform identification of a management transaction type from said user which said user would like to implement in said proposed management transaction;
Determining from said management transaction type one or more secondary parties for participating in said proposed management transaction;
Receiving at said derivative management platform a selection from said user of one or more secondary parties acceptable to said user for participating in said proposed management transaction;
Displaying for said acceptable secondary parties the characteristics of a proposed management transaction;
Within a pre-determined time frame, determining from said acceptable secondary parties whether said acceptable secondary parties desired to participate in said proposed management transaction;
Determining from any acceptable secondary parties who have indicated a desire to participate in said proposed management transaction whether said acceptable secondary parties who have indicated a desire to participate in said proposed management transaction are willing to participate dependent upon additional financial considerations;
When one or more acceptable secondary parties have indicated a desire to participate in said proposed management transaction, displaying to said user an acceptance from one or more acceptable secondary parties who have indicated a desire to participate in a proposed management transaction, and where said secondary parties who have indicated a desire to participate have identified additional financial considerations upon which said secondary parties who have indicated a desire to participate have conditioned said acceptance;
Within a pre-determined time frame, determining from said user whether said user accepts acceptance of said proposed management transaction from one of said one or more acceptable secondary parties who have indicated a desire to participate in a proposed management transaction; and
When said user accepts acceptance of said proposed management transaction from one of said one or more acceptable secondary parties who have indicated a desire to participate in a proposed management transaction, implementing said management transaction.

11. A computer implemented derivative instrument management process in accordance with claim 10, wherein said proposed management transaction is a termination, and wherein said secondary parties are potential step in parties.

12. A computer implemented derivative instrument management process in accordance with claim 10, wherein said proposed management transaction is a compaction process.

13. A computer implemented derivative instrument management process in accordance with claim 10, wherein said proposed management transaction is a unwind process, and wherein said secondary party is the counterparty to said one or more derivative positions that said user would like to include in said management transaction.

13. A computer implemented derivative instrument management process in accordance with claim 10, further comprising determining for said user a value associated with said one or more derivative positions that said user would like to include in said management transaction, said value comprising an estimated current market value of said one or more derivative positions that said user would like to include in said management transaction.

14. A computer implemented derivative instrument management process in accordance with claim 13, wherein said step of determining for said user a value associated with said one or more derivative positions further comprises transmitting from said derivative management platform a request to a third party valuation service a request for said third party valuation service to provide a valuation of said one or more derivative positions, receiving from said third party valuation service a valuation of said one or more derivative positions, and displaying said valuation of said one or more derivative positions to said user.

15. A computer implemented derivative instrument management process in accordance with claim 10, further comprising determining for said user a value associated with said one or more derivative positions that said user would like to include in said management transaction, said value comprising an estimated margin cost associated with said proposed management transaction.

16. A computer implemented derivative instrument management process in accordance with claim 14, wherein said step of determining for said user a value associated with said one or more derivative positions further comprises transmitting from said derivative management platform a request to a third party valuation service a request for said third party valuation service to provide a valuation of said one or more derivative positions, receiving from said third party valuation service a valuation of said one or more derivative positions, and displaying said valuation of said one or more derivative positions to said user.

17. A computer implemented derivative instrument management process in accordance with claim 10, further comprising determining for a secondary party a value associated with said one or more derivative positions that said user would like to include in said management transaction, said value comprising an estimated current market value of said one or more derivative positions that said user would like to include in said management transaction.

18. A computer implemented derivative instrument management process in accordance with claim 10, further comprising determining for a secondary party a value associated with said one or more derivative positions that said user would like to include in said management transaction, said value comprising an estimated margin cost associated with said proposed management transaction.

19. A computer implemented derivative instrument management process in accordance with claim 10, further comprising the steps of receiving from said user a desire to accept an acceptance of a proposed management transaction after said predetermined time has expired, communicating said desire to accept an acceptance of a proposed management transaction after said predetermined time has expired to the secondary party who had issued said acceptance, and determining from said secondary party whether the secondary party is willing to allow said user to accept said acceptance after expiration of said predetermined time frame.

20. A computer implemented derivative instrument management process in accordance with claim 19, further comprising the step of receiving from said secondary party who had issued said acceptance additional constraints on said acceptance, communicating said additional constraints to said user, and determining from said user whether said user accepts said additional constraints.
